(19) United States
(12) Patent Application Publication
(10) Pub. No.: US 2017/0090706 A1
(43) Pub. Date: Mar. 30, 2017

(54) User Created Presence Including Visual Presence for Contacts

(71) Applicant: Microsoft Technology Licensing, LLC, Redmond, WA (US)

(72) Inventors: Onur Cinar, Sunnyvale, CA (US); Vivek Thukral, Palo Alto, CA (US); Vijay Chandrasekaran, Sunnyvale, CA (US)

(21) Appl. No.: 14/871,491

(22) Filed: Sep. 30, 2015

(51) Int. Cl. G06F 3/0484; H04L 29/08

(52) U.S. Cl. CPC G06F 3/0484; H04L 67/24

(57) ABSTRACT

Various embodiments provide a communication application that enables users to create their own personalized presence statuses. Users are able to create non-textual presence statuses which are then able to be conveyed to their contacts as a means of informing their contacts of their particular status. The non-textual presence statuses are created in an interactive manner that provides a more informative personal touch. In addition, non-textual presence statuses provide a mechanism by which users may more efficiently enter a larger amount of data that, in turn, provides greater context about their presence status than predefined textual presence statuses provide.

### BACKGROUND

In today's world, there are hundreds, if not more, communication applications that enable users to communicate with one another. These applications can include instant messaging applications, e-mail applications, video conferencing applications, video communication applications, and the like. In the context of these applications, it can be very challenging to detect or maintain the exact presence status of a particular contact. Presence statuses can include such things as “available”, “busy”, “away”, “do not disturb”, and the like. Many applications allow users to make a predefined textual selection that provides a status into a suitable status field. For example, an application may have a drop-down menu or some other user interface instrumentality by which a user can select a predefined textual presence status. Once the predefined textual presence status has been selected, such can be conveyed to the user's contacts to allow the contacts to know the presence status of the user.

While predefined textual presence statuses convey some information about a particular user, the predefined nature makes the textual presence statuses somewhat sterile and impersonal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments provide a communication application that enables users to create their own personalized presence statuses. Users are able to create non-textual presence statuses which are then able to be conveyed to their contacts as a means of informing their contacts of their particular status. The non-textual presence statuses are created in an interactive manner that provides a fun, more informative personal touch. In addition, non-textual presence statuses provide a mechanism by which users may more efficiently enter a larger amount of data that, in turn, provides greater context about their presence status than predefined textual presence statuses provide.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 is an illustration of a system in an example implementation in accordance with one or more embodiments.

FIG. 4 illustrates an example user interface provided by a communication application in accordance with one or more embodiments.

FIG. 5 illustrates an example user interface provided by a communication application in accordance with one or more embodiments.

FIG. 6 is a flow diagram that describes steps in a method in accordance with one or more embodiments.

FIG. 7 illustrates an example user interface provided by a communication application in accordance with one or more embodiments.

FIG. 8 is a flow diagram that describes steps in a method in accordance with one or more embodiments.

FIG. 9 illustrates an example computing device that can be utilized to implement various embodiments described herein.

### DETAILED DESCRIPTION

### Overview

Various embodiments provide a communication application that enables users to create their own personalized presence statuses. Users are able to create non-textual presence statuses which are then able to be conveyed to their contacts as a means of informing their contacts of their particular status. The non-textual presence statuses are created in an interactive manner that provides a fun, more informative personal touch. Moreover, non-textual presence statuses, as described herein, allow users to provide much more information into their presence status in just about the same time it would take them to select a predefined textual presence status. That is, non-textual presence statuses provide a mechanism by which users may more efficiently enter a larger amount of data that, in turn, provides greater context about their presence status than predefined textual presence statuses provide. Further, in mobile scenarios in which devices have smaller form factors, it can be much easier for the user to provide non-textual presence statuses, at least in part, because the user interface to do so is less cluttered, as will become apparent below. In addition, ease of operation is facilitated in mobile or handheld device scenarios because large amounts of data can be entered using only a single handed operation.

In various embodiments, the non-textual presence statuses can reside in the form of a video that the user creates and records, a picture taken by the user, or an audio message that is recorded by the user. Once the user creates their non-textual presence status, the user can set the status as their presence. For example, assume that a particular user is at the beach and wishes to change their presence status. To do so, the user may record a video “selfie” with the ocean in the background along with a message “Hey everyone, I'm at the beach having a wonderful time.” Alternately, the user may take a picture of himself or herself with the ocean in the background, or make an audio recording with the sound of seagulls in the background and the message “Hi guys—I'm at the beach and wish you were here.” The user can then, through a suitable user interface instrumentality, set this content as his or her presence. In this way, when the user's contacts wish to know the status of the user, the user's presence status can be vividly and interactively shared with the contacts. As another example, consider a meeting-based scenario in which a user is about to enter a meeting. In this case, the user may make a video or audio recording stating that they are entering a meeting, yet not include specific details of the meeting. Viewers of the meeting may be able to ascertain further information from the recorded presence status, such as meeting venue and thereby make more enlightened choices regarding whether or not to contact the user based on the additional ascertained information. The various embodiments described above and below can also be used to support “Out of Office”, “Automatic replies” and other presence scenarios.

In the following discussion, an example environment is first described that is operable to employ the techniques described herein. The techniques may be employed in the example environment, as well as in other environments.

Example Environment

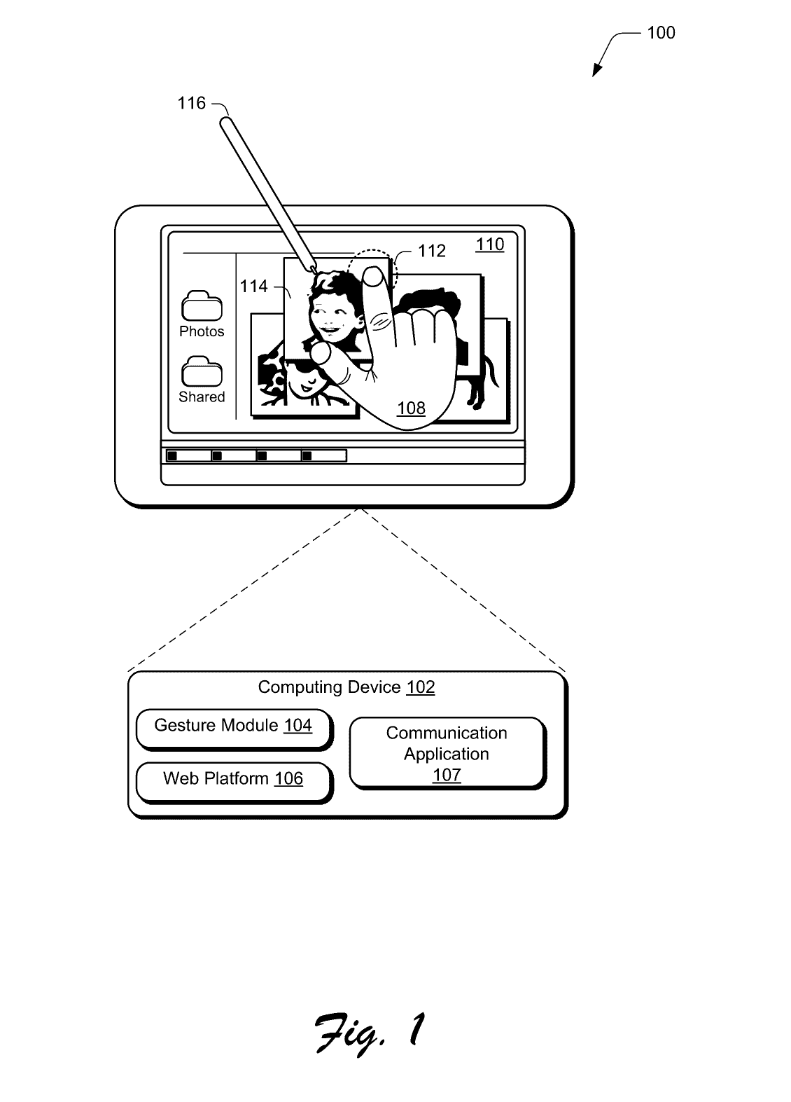

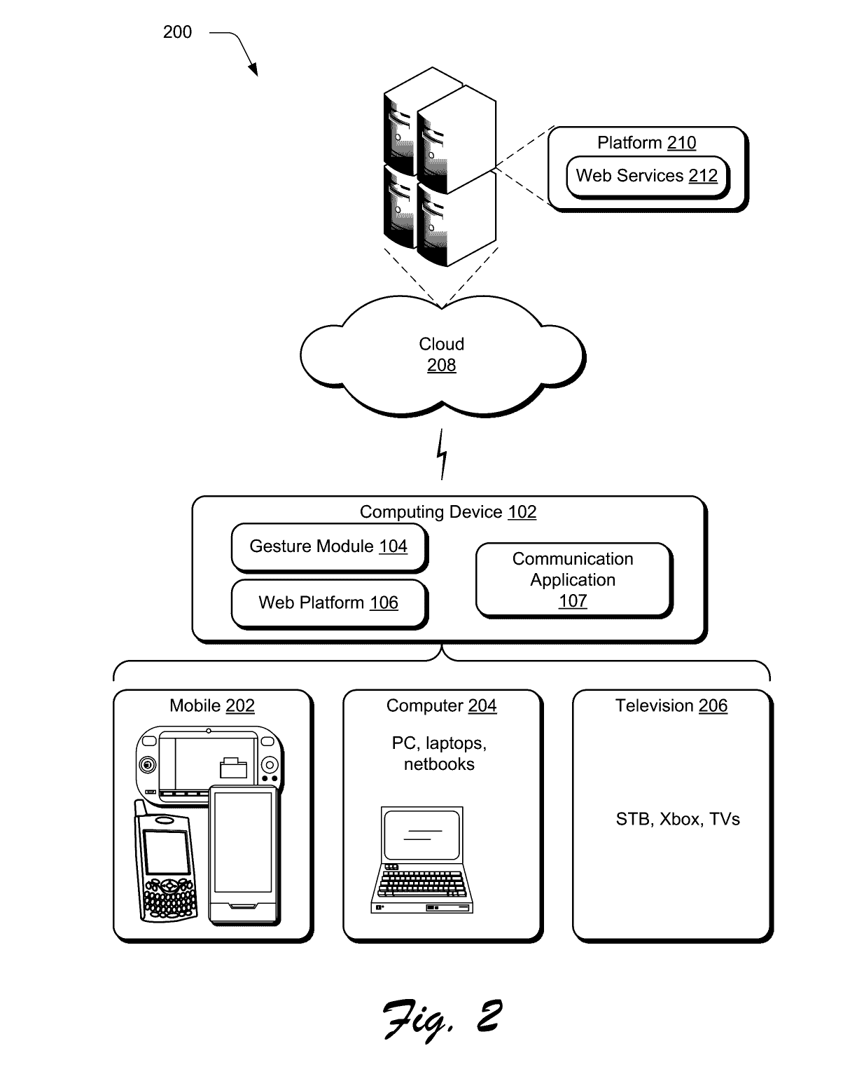

FIG. 1 is an illustration of an environment 100 in an example implementation that is operable to employ the techniques as described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

In this example, computing device 102 includes, among other components, a gesture module 104, a web platform 106, and a communication application 107.

The gesture module 104 is operational to provide gesture functionality as described in this document. The gesture module 104 can be implemented in connection with any suitable type of hardware, software, firmware or combination thereof. In at least some embodiments, the gesture module 104 is implemented in software that resides on some type of computer-readable storage medium, examples of which are provided below.

Gesture module 104 is representative of functionality that recognizes gestures that can be performed by one or more fingers, and causes operations to be performed that correspond to the gestures. The gestures may be recognized by module 104 in a variety of different ways. For example, the gesture module 104 may be configured to recognize a touch input, such as a finger of a user's hand 108 as proximal to display device 110 of the computing device 102 using touchscreen functionality. For example, a finger of the user's hand 108 is illustrated as selecting 112 an image 114 displayed by the display device 110.

It is to be appreciated and understood that a variety of different types of gestures may be recognized by the gesture module 104 including, by way of example and not limitation, gestures that are recognized from a single type of input (e.g., touch gestures such as the previously described drag-and-drop gesture) as well as gestures involving multiple types of inputs. For example, module 104 can be utilized to recognize single-finger gestures and bezel gestures, multiple-finger/same-hand gestures and bezel gestures, and/or multiple-finger/different-hand gestures and bezel gestures.

For example, the computing device 102 may be configured to detect and differentiate between a touch input (e.g., provided by one or more fingers of the user's hand 108) and a stylus input (e.g., provided by a stylus 116). The differentiation may be performed in a variety of ways, such as by detecting an amount of the display device 110 that is contacted by the finger of the user's hand 108 versus an amount of the display device 110 that is contacted by the stylus 116.

Thus, the gesture module 104 may support a variety of different gesture techniques through recognition and leverage of a division between stylus and touch inputs, as well as different types of touch inputs.

The web platform 106 is a platform that works in connection with content of the web, e.g. public content. A web platform 106 can include and make use of many different types of technologies such as, by way of example and not limitation, URLs, HTTP, REST, HTML, CSS, JavaScript, DOM, and the like. The web platform 106 can also work with a variety of data formats such as XML, JSON, and the like. Web platform 106 can include various web browsers, web applications (i.e. “web apps”), and the like. When executed, the web platform 106 allows the computing device to retrieve web content such as electronic documents in the form of webpages (or other forms of electronic documents, such as a document file, XML file, PDF file, XLS file, etc.) from a Web server and display them on the display device 110. It should be noted that computing device 102 could be any computing device that is capable of displaying Web pages/documents and connect to the Internet.

Communication application 107 is representative of software that enables communication with other users using the techniques described above and below. The communication application may include an instant messaging application, an e-mail application, a video conferencing application, a video communication application, and the like.

FIG. 2 illustrates an example system showing the components of FIG. 1, e.g., communication application 107, as being implemented in an environment where multiple devices are interconnected through a central computing device. The communication application 107 enables users to create their own personalized presence statuses. Users are able to create non-textual presence statuses which are then able to be conveyed to their contacts as a means of informing their contacts of their particular status. The non-textual presence statuses are created in an interactive manner that provides a fun, more informative personal touch, as described above and below.

The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, tablets, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks. For example, the communication application 107, or aspects thereof, may be implemented in part on the computing device 102 as well as via a platform 210 that supports web services 212. For example, the communication application 107 can be used to create and set presence status which is then maintained by platform 210 and, more specifically, Web services 212. The presence status can then be made available to the user's contacts as appropriate.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices.

The computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

In the discussion that follows, a section entitled “Example System” describes an example system in accordance with one or more embodiments. Next, a section entitled “Creating a Non-Textual Presence Status” describes embodiments in which a non-textual presence status may be created in accordance with one or more embodiments. Following this, a section entitled “Sharing Non-Textual Presence Status” describes how non-textual presence status may be shared in accordance with one or more embodiments. Next, a section entitled “Notifications” describes how notifications may be used to notify contacts of a change in presence status. Following this, a section entitled “Power Savings” describes power saving aspects in accordance with one or more embodiments. Next, a section entitled “Example Device” describes aspects of an example device that can be utilized to implement one or more embodiments. Last, a section entitled “Example Implementations” describes example implementations in accordance with one or more embodiments.

Example System

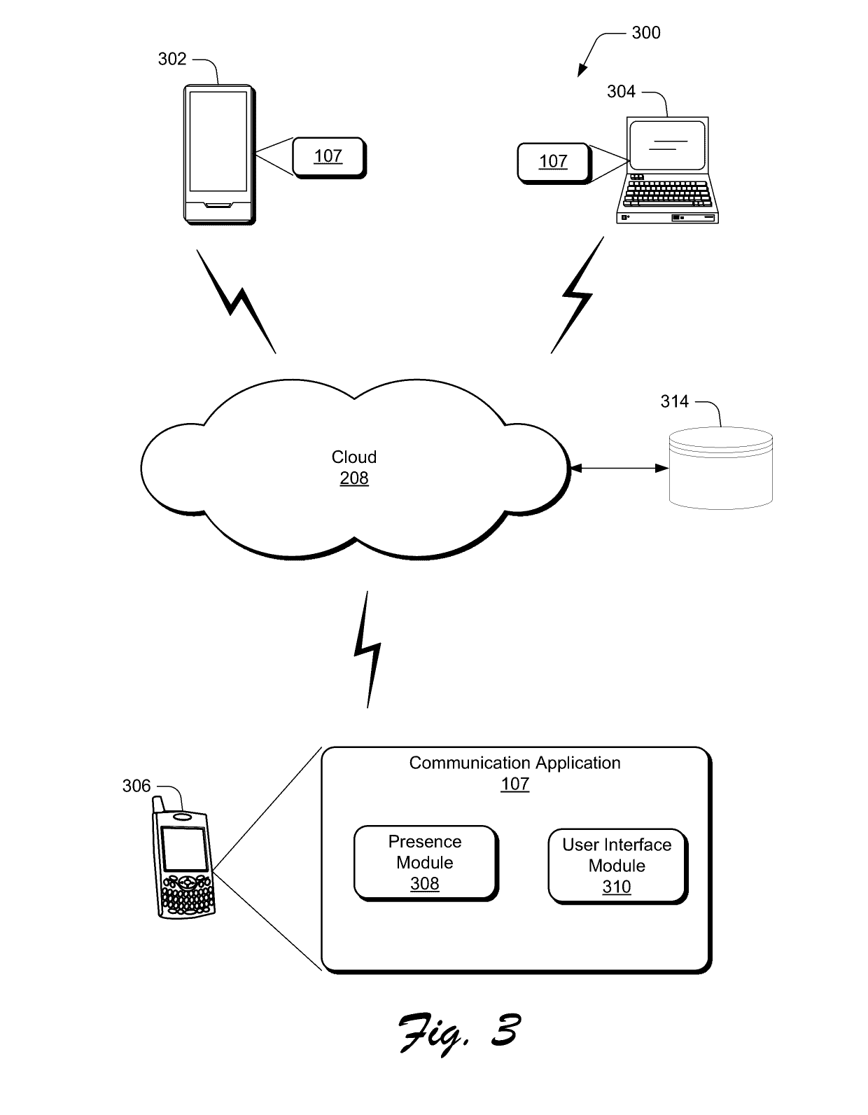

FIG. 3 illustrates an example system in accordance with one or more embodiments generally at 300. In the example about to be described, system 300 enables a user to interact with a communication application to create their own personalized presence statuses. Users are able to create non-textual presence statuses which are then able to be conveyed to their contacts as a means of informing their contacts of their particular status. The presence statuses can be maintained in a data store and shared out amongst the user's contacts as appropriate.

In this example, system 300 includes devices 302, 304, and 306. Each of the devices is communicatively coupled with one another by way of cloud 208, e.g., the Internet or an Intranet. In this particular example, each device includes a communication application 107 which includes functionality that enables users to create their own unique presence status as described above and below. In addition, aspects of the communication application 107 can be implemented by cloud 208 which can utilize a suitably-configured database or data store 314 to store information associated with various users' presence statuses.

In this particular example, the communication applications resident on devices 302, 304, and 306 can include or otherwise make use of one or more of a presence module 308 and a user interface module 310.

In the illustrated and described embodiment, presence module 308 is representative of functionality that enables a user to create their own personalized presence statuses. Users are able to create non-textual presence statuses which are then able to be conveyed to their contacts as a means of informing their contacts of their particular status. Once created, the user's presence status and other relevant information can be provided to the cloud and maintained so that it can be shared out to the user's contacts.

User interface module 310 is representative of functionality that enables the user to interact with the communication application in order to create their own unique non-textual presence status and communicate the present status to the cloud 208.

Consider now an example of how a user can create their own non-textual presence status.

Creating a Non-Textual Presence Status

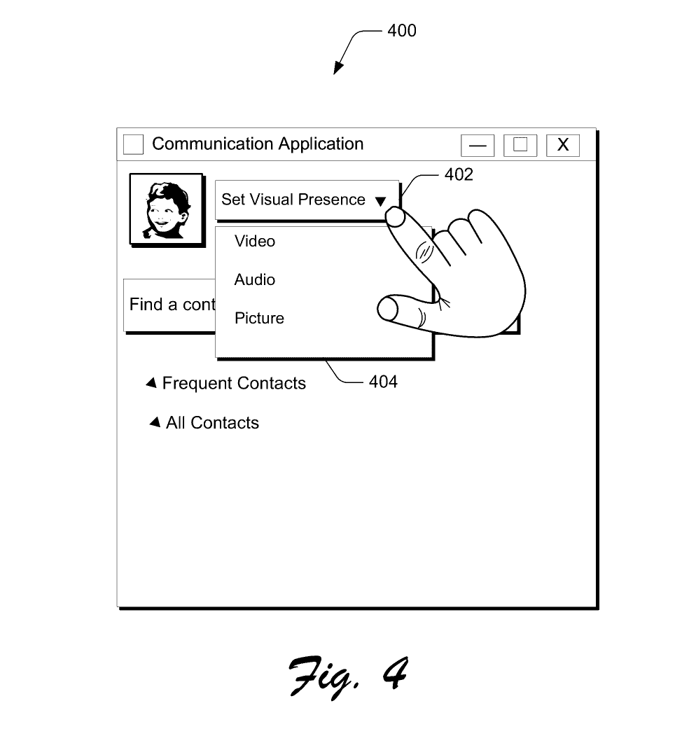

FIG. 4 illustrates an example user interface 400 that is provided by user interface module 310 of the communication application. In this example, a picture icon represents the user. Next to the picture icon, a user instrumentality in the form of a touch-selectable button designated “Set Visual Presence” appears. When the user touch selects this button, a window 404 appears and provides various options for the user to create their non-textual presence status. In this example there are three selections—video, audio, and picture. By touch selecting one of these options, the user can create their own unique non-textual presence status. In mobile environments in which the user interface footprint is much smaller than, for example, desktop environments, the illustrated user interface can more easily allow a user to create their presence status. This is due, at least in part, to a user interface that is less busy and that has reduced clutter. For example, in the context of predefined, textual presence statuses there are often many choices from which to choose, e.g. five, six, seven or more. In this particular example, there are three choices from which to choose—video, audio, and picture. Thus, the choices can be presented in a larger font size, thus making touch selection much easier.

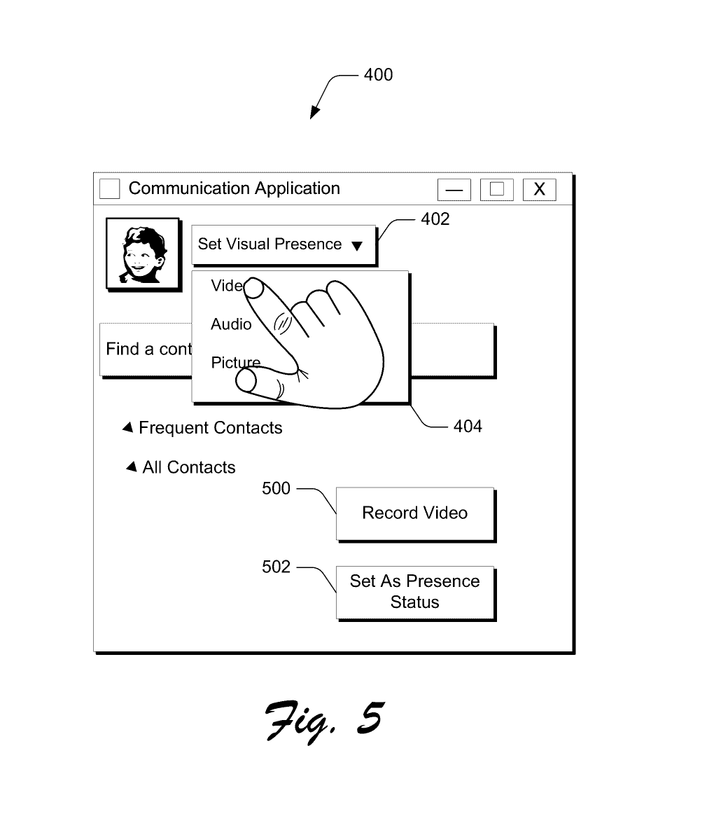

As an example, consider FIG. 5 which illustrates user interface 400 from FIG. 4. Here, the user has touch selected the “video” option. To create their own unique video, the user can select a button 500 designated “Record Video”. When the user selects this button, the computing device's front facing camera can be activated and utilized to enable the user to record their own video, along with accompanying audio. After the video has been made, the user can select a button 502 designated “Set As Presence Status”. In at least some embodiments, selecting button 502 causes the video to be sent to a remote web service that manages presence information across multiple users. By doing so, the user's non-textual presence status can be made available to the user's contacts.

The experience just described is similar for each of the other options, namely, the audio option and the picture option.

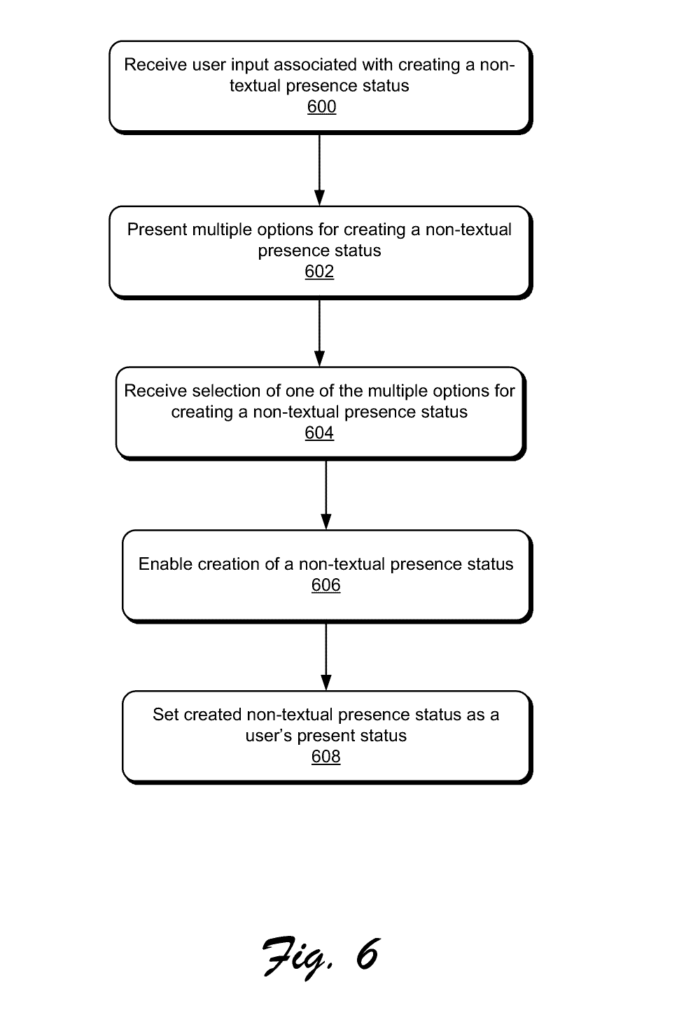

FIG. 6 is a flow diagram that describes steps in a method in accordance with one or more embodiments. The method can be implemented in connection with any suitable hardware, software, firmware, or combination thereof. In one or more embodiments, aspects of the method can be implemented by a suitably-configured communication application such as those described above and below.

Step 600 receives user input associated with creating a non-textual presence status in a communication application. This step can be performed in any suitable way. In at least some embodiments, a user interface is presented to enable the user to create a non-textual presence status. By selecting a suitably-configured user interface instrumentality, the user can create their own present status. Responsive to receiving the user input, step 602 presents multiple options for creating a non-textual presence status. Any suitable type and number of options can be presented. In the illustrated and described embodiment, three different options are presented. Specifically, the user may create a video, audio recording, or may take a picture. In addition to presenting the non-textual options, in at least some embodiments the user interface can enable standard, pre-defined presence statuses to be selected by the user such as “available”, “busy”, “be right back”, and the like. Further, it is to be appreciated and understood that step 602 may present a single option to create a non-textual presence status. For example, a single option might be presented to create a video. Alternately or additionally, a single option might be presented to create an audio recording. Alternately or additionally, a single option might be presented to create or take a picture.

Step 604 receives selection of one of the multiple options for creating a non-textual presence status. Responsive to receiving the selection, step 606 enables creation of a non-textual presence status. This step can be performed in any suitable way. For example, in situations where the user has selected the video option, this step can be performed by enabling activation of a device video camera (either front facing or rear facing camera) to allow the user to create a video that includes audio content as well. In situations where the user has selected the audio option, this step can be performed by enabling activation of a device microphone in order to allow audio to be captured and saved. In situations where the user has selected the picture option, this step can be performed by enabling activation of a device camera to allow the picture to be taken.

Step 608 sets the created non-textual presence status as the user's presence status. This step can be performed in any suitable way. For example, in at least some embodiments this step can be performed by presenting a user interface instrumentality, such as button 502 in FIG. 5, to allow the user to set their status. Once the status has been set, the presence status can be shared amongst the user's contacts as appropriate.

Having considered examples of how the user can create a non-textual presence status, consider now how that presence status can be shared with their contacts.

Sharing Non-Textual Presence Status

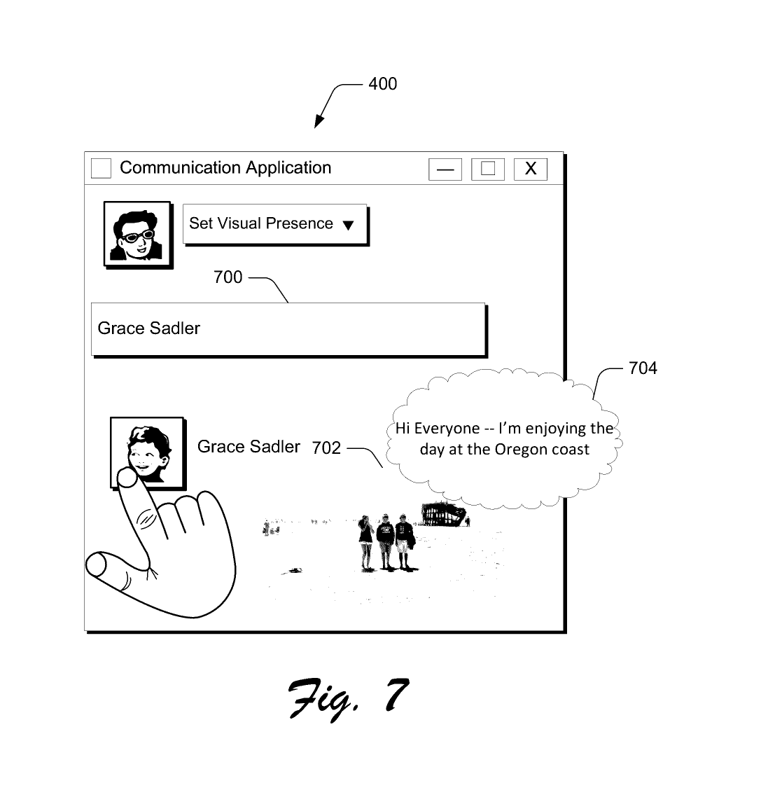

FIG. 7 illustrates a user interface 400 of the communication application discussed above. In this particular example, the user has searched for a particular contact, “Grace Sadler”, by typing search text in a box 700. The search has returned Grace's icon or profile. By hovering a mouse over Grace's icon or by tap selecting the icon, the communication application presents a window 702, retrieves Grace's presence status from a location such as a web service, and displays Grace's presence status. In this particular example, Grace has created a video at the Oregon coast. As the video plays, the recorded audio says “Hi everyone—I'm enjoying the day at the Oregon coast.”

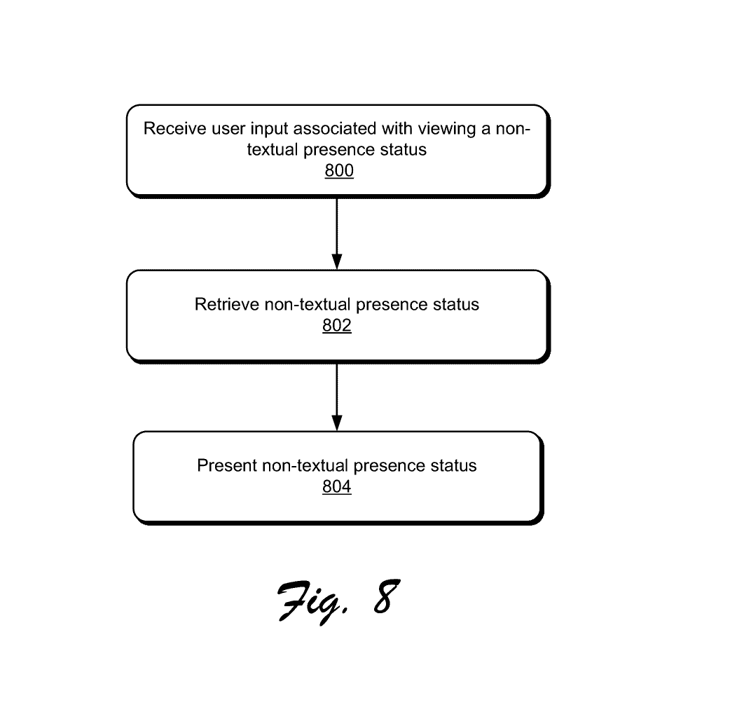

FIG. 8 is a flow diagram that describes steps in a method in accordance with one or more embodiments. The method can be implemented in connection with any suitable hardware, software, firmware, or combination thereof. In one or more embodiments, aspects of the method can be implemented by a suitably-configured communication application such as those described above and below.

Step 800 receives user input associated with viewing a non-textual presence status. This step can be performed in any suitable way. For example, this step can be performed by receiving user input by way of a suitably-configured input device such as a mouse, stylus, and the like. The input device can be used to select a particular user's profile in a communication application such as those described above. Alternately or additionally, this step can be performed by receiving touch input, as by receiving a touch selection of a user's profile. As noted above, non-textual presence status may come in a variety of forms such as, by way of example and not limitation, a video, a picture, or an audio recording.

Responsive to receiving the user input, step 802 retrieves the associated non-textual presence status. This step can be performed in any suitable way. For example, in some scenarios the non-textual presence status may be stored locally on the user's computing device. Alternately or additionally, in some scenarios the non-textual presence status may be stored remotely such as at a remote web service. Step 804 presents the non-textual presence status on the user's computing device. This step can be performed in any suitable way. For example, in scenarios where the non-textual presence status comprises a video, the communication application can present a window and render the video in the window for the user. Alternately or additionally, if the non-textual presence status comprises a picture, the communication application can present a window and render the picture in the window for the user. Alternately or additionally, if the non-textual presence status comprises an audio recording, the communication application can play the audio recording for the user.

Having considered various embodiments in which non-textual presence statuses can be created by a user and consumed by the user's contacts, consider now a discussion of notifications.

Notifications

In one or more embodiments, when a user creates a new non-textual presence status, a notification can be sent from the user's computing device to their contacts or to a subset of their contacts. The notification may or may not include the actual content of the non-textual presence status.

For example, assume that a user has defined a subset of their contacts as “Close Friends.” In addition, in the user's communication application, the user has selected a setting that automatically notifies their Close Friends when the user has changed their non-textual presence status. In addition, there may be a separate setting that the user may select in order to provide the actual content of the non-textual presence status to their Close Friends. So, for example, if the user creates a new video for their presence status, a notification along with the actual video may be sent to all of the contacts that appear in their Close Friends.

Having considered aspects of notifications in accordance with one or more embodiments, consider now a discussion of power saving aspects associated with non-textual presence status.

Power Savings

In some scenarios, a user's device may have limited battery life. For example, the user's device may be a lower end device with limited battery power. In scenarios such as this, it may be desirable to take steps to conserve power in connection with retrieving and presenting non-textual presence statuses.

For example, consider a situation in which the user of a lower end device wishes to view the present status of their friends. One of their friends has recorded a video as a presence status. In this situation when the user provides input indicating that they wish to view their friend's presence status, an indication may also be provided that the requesting device is a lower end device or a device with limited battery life. Accordingly, when the presence status is retrieved, instead of returning the video, the web service or other remote location may simply return a frame captured from the video. In this manner, the video may not be played by the user's device, thus conserving power. The user's communication application may, however, give the user an option of selecting the video for viewing.

Having described various embodiments and features associated with non-textual presence status, consider now a device that can be utilized to implement one or more embodiments described above.

Example Device

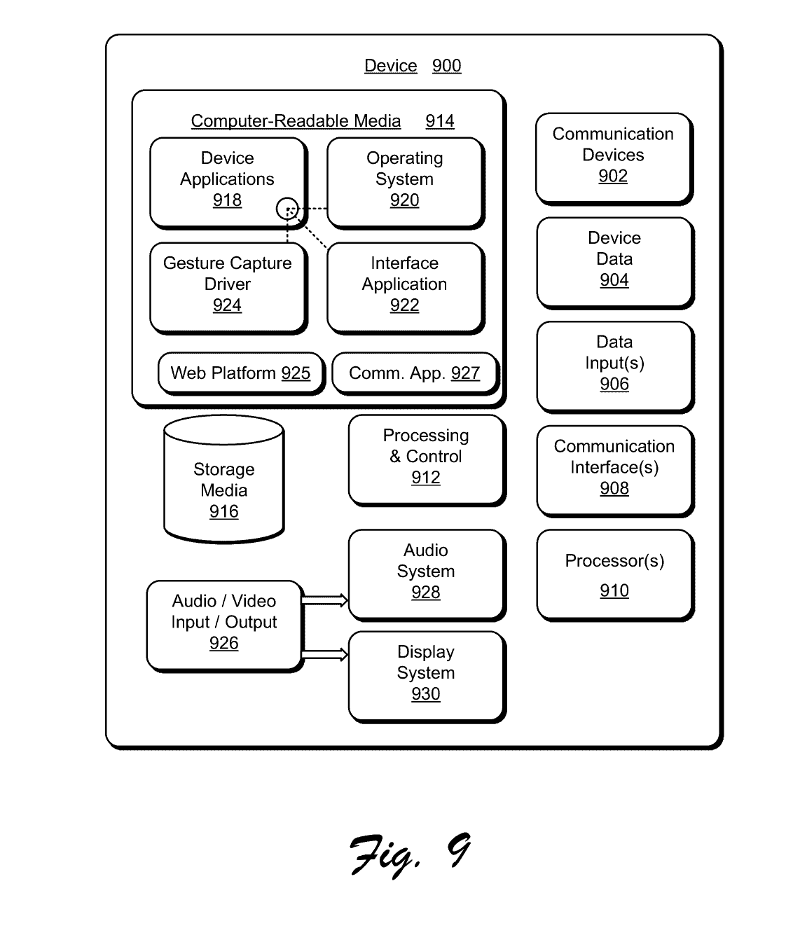

FIG. 9 illustrates various components of an example device 900 that can be implemented as any type of computing device as described with reference to FIGS. 1 and 2 to implement embodiments of the techniques described herein. Device 900 includes communication devices 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Media content stored on device 900 can include any type of audio, video, and/or image data. Device 900 includes one or more data inputs 906 via which any type of data, media content, and/or inputs can be received, such as user-selectable inputs, messages, music, television media content, recorded video content, and any other type of audio, video, and/or image data received from any content and/or data source.

Device 900 also includes communication interfaces 908 that can be implemented as any one or more of a serial and/or parallel interface, a wireless interface, any type of network interface, a modem, and as any other type of communication interface. The communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like) which process various computer-executable instructions to control the operation of device 900 and to implement embodiments of the techniques described herein. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable media 914, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device 916.

Computer-readable media 914 provides data storage mechanisms to store the device data 904, as well as various device applications 918 and any other types of information and/or data related to operational aspects of device 900. For example, an operating system 920 can be maintained as a computer application with the computer-readable media 914 and executed on processors 910. The device applications 918 can include a device manager (e.g., a control application, software application, signal processing and control module, code that is native to a particular device, a hardware abstraction layer for a particular device, etc.). The device applications 918 also include any system components or modules to implement embodiments of the techniques described herein. In this example, the device applications 918 include an interface application 922 and a gesture capture driver 924 that are shown as software modules and/or computer applications. The gesture capture driver 924 is representative of software that is used to provide an interface with a device configured to capture a gesture, such as a touchscreen, track pad, camera, and so on. Alternatively or in addition, the interface application 922 and the gesture capture driver 924 can be implemented as hardware, software, firmware, or any combination thereof. Additionally, computer readable media 914 can include a web platform 625 and a communication application 927 that functions as described above.

Device 900 also includes an audio and/or video input-output system 926 that provides audio data to an audio system 928 and/or provides video data to a display system 930. The audio system 928 and/or the display system 930 can include any devices that process, display, and/or otherwise render audio, video, and image data. Video signals and audio signals can be communicated from device 900 to an audio device and/or to a display device via an RF (radio frequency) link, S-video link, composite video link, component video link, DVI (digital video interface), analog audio connection, or other similar communication link. In an embodiment, the audio system 928 and/or the display system 930 are implemented as external components to device 900. Alternatively, the audio system 928 and/or the display system 930 are implemented as integrated components of example device 900.

### Example Implementations

Example implementations of techniques described herein include, but are not limited to, one or any combinations of one or more of the following examples:

### Example 1

A computer-implemented method comprising: receiving, by a computing device, a user input associated with creating a non-textual presence status in a communication application; responsive to receiving the user input, presenting, by the computing device, multiple options for creating a non-textual presence status; receiving, by the computing device, selection of one of the multiple options for creating a non-textual presence status; and responsive to receiving selection, enabling, by the computing device, creation of a non-textual presence status.

### Example 2

A method as described in any one or more of the examples in this section, wherein one of the multiple options is a video option.

### Example 3

A method as described in any one or more of the examples in this section, wherein one of the multiple options is an audio recording option.

### Example 4

A method as described in any one or more of the examples in this section, wherein one of the multiple options is a picture option.

### Example 5

A method as described in any one or more of the examples in this section, wherein said enabling comprises activating a device video camera.

### Example 6

A method as described in any one or more of the examples in this section, wherein said enabling comprises activating a front facing device video camera.

### Example 7

A method as described in any one or more of the examples in this section, wherein said enabling comprises activating a device microphone in order to allow audio to be captured and saved

### Example 8

A method as described in any one or more of the examples in this section, wherein said enabling comprises activating a device camera to allow a picture to be taken.

### Example 9

A method as described in any one or more of the examples in this section, further comprising setting the created non-textual presence status as the user's presence status.

### Example 10

A method as described in any one or more of the examples in this section, further comprising sending, to one or more contacts, a notification that a new non-textual presence status has been created.

### Example 11

A computing device comprising: one or more processors; one or more computer readable media storing computer readable instructions which, when executed, implement a communication application configured to perform operations comprising: receiving user input associated with viewing a non-textual presence status associated with the communication application; responsive to receiving the user input, retrieving the associated non-textual presence status; and presenting the non-textual presence status on the computing device.

### Example 12

A computing device as described in any one or more of the examples in this section, wherein the non-textual presence status comprises a video.

### Example 13

A computing device as described in any one or more of the examples in this section, wherein the non-textual presence status comprises a picture.

### Example 14

A computing device as described in any one or more of the examples in this section, wherein the non-textual presence status comprises an audio recording.

### Example 15

A computing device as described in any one or more of the examples in this section, wherein said presenting comprises rendering a video on the computing device, the video being associated with a contact in the communication application.

### Example 16

A computing device as described in any one or more of the examples in this section, wherein said presenting comprises rendering a picture on the computing device, the picture being associated with a contact in the communication application.

### Example 17

A computing device as described in any one or more of the examples in this section, wherein said presenting comprises playing an audio recording on the computing device, the audio being associated with a contact in the communication application.

### Example 18

A computing device comprising: one or more processors; one or more computer readable media storing computer readable instructions which, when executed, implement a communication application configured to perform operations comprising: receiving a user input associated with creating a non-textual presence status in the communication application; responsive to receiving the user input, presenting at least one option for creating a non-textual presence status; receiving selection of an option sufficient to enable creation of a non-textual presence status; and responsive to receiving the selection, enabling creation of a non-textual presence status.

### Example 19

A computing device as described in any one or more of the examples in this section, wherein said at least one option is a video option.

### Example 20

A computing device as described in any one or more of the examples in this section, wherein said at least one option is an audio recording option.

### Example 21

A computing device as described in any one or more of the examples in this section, wherein said at least one option is a picture option.

### CONCLUSION

Various embodiments provide a communication application that enables users to create their own personalized presence statuses. Users are able to create non-textual presence statuses which are then able to be conveyed to their contacts as a means of informing their contacts of their particular status. The non-textual presence statuses are created in an interactive manner that provides a fun, more informative personal touch.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
receiving, by a computing device, a user input associated with creating a non-textual presence status in a communication application;
responsive to receiving the user input, presenting, by the computing device, multiple options for creating a non-textual presence status;
receiving, by the computing device, selection of one of the multiple options for creating a non-textual presence status; and
responsive to receiving selection, enabling, by the computing device, creation of a non-textual presence status.

2. The method of claim 1, wherein one of the multiple options is a video option.

3. The method of claim 1, wherein one of the multiple options is an audio recording option.

4. The method of claim 1, wherein one of the multiple options is a picture option.

5. The method of claim 1, wherein said enabling comprises activating a device video camera.

6. The method of claim 1, wherein said enabling comprises activating a front facing device video camera.

7. The method of claim 1, wherein said enabling comprises activating a device microphone in order to allow audio to be captured and saved.

8. The method of claim 1, wherein said enabling comprises activating a device camera to allow a picture to be taken.

9. The method of claim 1 further comprising setting the created non-textual presence status as the user's presence status.

10. The method of claim 1 further comprising sending, to one or more contacts, a notification that a new non-textual presence status has been created.

11. A computing device comprising:
one or more processors;
one or more computer readable media storing computer readable instructions which, when executed, implement a communication application configured to perform operations comprising:
receiving user input associated with viewing a non-textual presence status associated with the communication application;
responsive to receiving the user input, retrieving the associated non-textual presence status; and
presenting the non-textual presence status on the computing device.

12. The computing device of claim 11, wherein the non-textual presence status comprises a video.

13. The computing device of claim 11, wherein the non-textual presence status comprises a picture.

14. The computing device of claim 11, wherein the non-textual presence status comprises an audio recording.

15. The computing device of claim 11, wherein said presenting comprises rendering a video on the computing device, the video being associated with a contact in the communication application.

16. The computing device of claim 11, wherein said presenting comprises rendering a picture on the computing device, the picture being associated with a contact in the communication application.

17. The computing device of claim 11, wherein said presenting comprises playing an audio recording on the computing device, the audio being associated with a contact in the communication application.

18. A computing device comprising:
one or more processors;
one or more computer readable media storing computer readable instructions which, when executed, implement a communication application configured to perform operations comprising:
receiving a user input associated with creating a non-textual presence status in the communication application;
responsive to receiving the user input, presenting at least one option for creating a non-textual presence status;
receiving selection of an option sufficient to enable creation of a non-textual presence status; and
responsive to receiving the selection, enabling creation of a non-textual presence status.

19. The computing device of claim 18, wherein said at least one option is a video option.

20. The computing device of claim 18, wherein said at least one option is an audio recording option.

21. The computing device of claim 18, wherein said at least one option is a picture option.
